(19) United States
(12) Patent Application Publication
(10) Pub. No.: US 2009/0164273 A1
(43) Pub. Date: Jun. 25, 2009

(54) PRODUCT DISTRIBUTION SYSTEM AND METHOD THEREOF

(75) Inventor: Simon Rothman, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Glyde Corporation, Palo Alto, CA (US)

(21) Appl. No.: 11/963,470

(22) Filed: Dec. 21, 2007

(51) Int. Cl. G06Q 30/00; G06F 17/00

(52) U.S. Cl. 705/7

(57) ABSTRACT

A system and method for distributing a product purchased on the internet According to one embodiment, information associated with a plurality of sellers is stored in a database. This information includes the address of each seller and the dimensions and weight associated with a product to be sold by the seller. Buyer information is also stored in a database. Upon receiving a purchase order from a buyer, which includes at least one product to be purchased, an appropriate mailer is automatically determined based upon the dimensions and weight of the product. Moreover, an optimum mail class is automatically determined based on the geographic location of the buyer and seller, and the size and weight of the product. The mailer is pre-addressed, pre-stamped, and then sent to the seller for the seller to prepare the product for final delivery to the buyer.

### CROSS-REFERENCES TO RELATED APPLICATIONS

Related applications are Ser. No. ______, “Virtual Shelf with Single Product Choice and Automatic Multiple Vendor Selection” [Attorney Docket no. 027050-000100US]; Ser. No. ______, entitled “System and Method for Dynamic Product Pricing” [Attorney Docket no. 027050-00200US]; Ser. No. ______, entitled “Software System for Decentralizing eCommerce with Single Page Buy” [Attorney Docket No.: 027050-000300US]; Ser. No. ______, entitled 3D Product Display on Internet with Content or Transaction Data on Back of Image” [Attorney Docket No.: 027050-000400US]; Ser. No. ______, “System and Method for Providing Real-Time Search Results on Merchandise” [Attorney Docket No.: 027050-000600US]; Ser. No. ______, “System and Method for Integrated Payment and Shipping Information” [Attorney Docket No.: 027050-000700US]; all filed even date herewith.

### BACKGROUND OF THE INVENTION

The present invention relates to a method and system for facilitating an internet commerce transaction. More particularly, embodiments of the present invention relate to a method and system for determining and distributing an appropriate mailer used to deliver a product purchased from a website.

Postal mailing services are one of the oldest and most reliable forms of parcel and document delivery. Holiday cards, letters, bills, and small goods are just a few of the many items commonly sent through the mail. Envelopes and boxes of different sizes are used to package and send the letters and small goods to a recipient. For example, when shopping for a holiday card, there are many different sized cards to choose from. Fortunately, most card stores conveniently place an appropriate sized envelope behind each card.

Today, remittance envelopes are used by charities, schools, and billing agencies to provide a quick and efficient way for sending payment of fees. These remittance envelopes are prepaid and are included within the original envelope sent to the remittee. Though, this delivery method is convenient for check and money order payments, it is not as convenient for small goods.

Moreover, since the advent of the internet, ecommerce has become a popular method for purchase of commodities such as DVDs, books and compact discs. Various websites including eBay, Craigslist, and Amazon Marketplace allow individual sellers and buyers to post and shop for virtually any desired item. Unfortunately, shipping costs are often hard to estimate, and preparation and shipment of the product tends to inconvenience the seller (eg. finding an appropriate sized box, traveling to a shipping vendor, etc.). Therefore, alternative means for delivering goods purchased online have been deployed.

NetFlix, the largest online rental DVD service, provides flat-rate rental by mail to millions of customers. A subscriber creates a list of desired DVDs to rent, and NetFlix sends the subscriber a DVD within a pre-addressed, pre-stamped return envelope. When a subscriber would like to rent a new DVD, the subscriber simply places the previous DVD in the preaddressed envelope and drops it in the mailbox. Accordingly, an efficient and timely delivery service can be accomplished between the subscriber and the NetFlix distribution center. This delivery method is practical because all the products are the same size, have the same return address, and require the same postage amount. However, this delivery method is not as convenient when the products vary in size and when the return address varies from purchase to purchase.

Mr. Swap.com, U.S. Patent Publication No. 2002/0032668, describes a delivery method for goods offered over the internet In this invention, a buyer locates an on-line seller in order to initiate a product(s) swap. After the seller and buyer agree on the product(s) for trade, a mailer with appropriate postage calculated is sent to the seller for the seller to place the product(s) in the mailer and send the mailer along with the product(s) to the buyer. However, an inconvenience still lies in that a buyer must search through a litany of sellers offering the same product, and must also choose a proper delivery method (mail class).

Therefore, a more efficient and convenient method and system for delivering products purchased online is needed.

### BRIEF SUMMARY OF THE INVENTION

Embodiments of the present invention generally relate to a method for distributing a product purchased over the internet More particularly, embodiments of the invention provide a method for automatically determining an appropriate size mailer, postage amount, and optimum mail class while facilitating an on-line transaction for any item between any two parties.

According to one embodiment, information associated with a plurality of sellers is stored in a database. This information includes the address of each seller and the dimensions and weight associated with a product to be sold by the seller. Buyer information is also stored in a database. Upon receiving a purchase order from a buyer, which includes at least one product to be purchased, an appropriate mailer is automatically determined based upon the dimensions and weight of the product. Moreover, an optimum mail class is automatically determined based on the geographic location of the buyer and seller, and the type, size, and weight of the product. The mailer is pre-addressed and pre-stamped and then sent to the seller for the seller to insert the product for final delivery to the buyer.

In one embodiment, a preferred seller amongst the plurality of sellers is determined based on the delivery speed, delivery costs, item price, and a reliability rating of a particular seller. Moreover, the distribution center utilizes an outer mailer for sending the inner mailer to the seller. Only mail classes that provide tracking are used, so that the system can automatically track product shipping dates from the seller to the buyer, and thus determine seller reliability without the need to rely on user feedback. Multiple mail distribution centers may be provided, and the system will select the center geographically closest to the preferred seller, so that the cost and time to get the mailer to the preferred seller will be minimized.

Several advantages are afforded by the embodiments of the present invention. The inventor recognized that there are significant variations in delivery times and postage costs depending on the mail class selected for certain products, and that this determination is not simple, confusing the average buyer and many sellers. Since the present invention automatically determines the optimum mail class based on the fastest delivery speed and/or lowest delivery cost, the buyer and seller do not need to figure out the best mail class. In addition, the use of mail classes that allow tracking, enables a direct determination of seller reliability. Also, any additional lead time associated with sending the mailer to the seller (as opposed to the seller being responsible for packaging, postage and mail class selection) is reduced by the determination of the optimum mail class. Ultimately, this delivery method reduces the processing time of online product purchase and makes the delivery process logistically easier for the seller.

### BRIEF DESCRIPTION OF THE DRAWINGS

FIG. 1 is a simplified diagram illustrating the overall system according to an embodiment of the present invention.

FIG. 2 is a flow diagram illustrating the process of the product distribution system according to an embodiment of the present invention.

FIGS. 3A and 3B are simplified perspective views of an inner and outer mailer according to an embodiment of the present invention.

### DETAILED DESCRIPTION OF THE INVENTION

A system and method for product distribution is disclosed. The following description is provided to enable any person skilled in the art to make and use the invention and sets forth the best modes contemplated by the inventor for carrying out the invention. Various modifications will remain readily apparent to those skilled in the art. Any and all such modifications, equivalents and alternatives are intended to fall within the spirit and scope of the present invention.

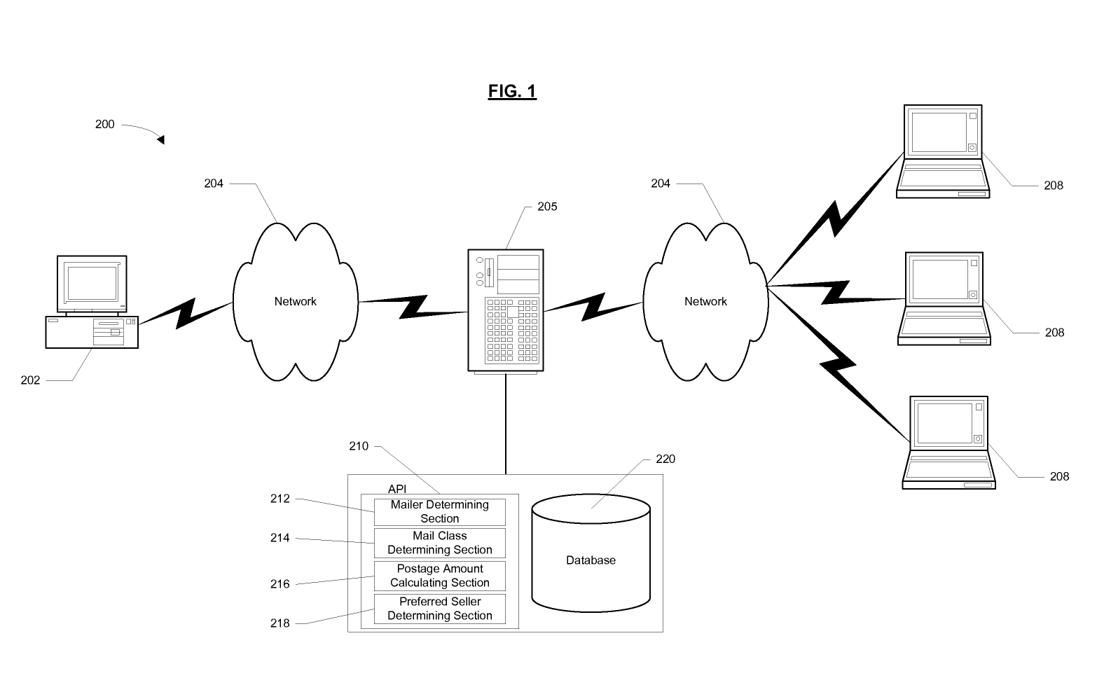

FIG. 1 is a simplified diagram of the overall product distribution system according to an embodiment of the present invention. As shown, the system 200 includes terminals 202 and 208, network 204 (i.e. the internet), server 205, application 210, and database 220. The terminals 202 and 208 are connected to server 205 via network 204. Terminal 202 is a buyer terminal, and terminals 208 are seller terminals.

The server 205 includes application 210 and database 220. In a specific embodiment, the server 205 hosts a multi-vendor website that offers certain products for sale. The server may be implemented using multiple computing devices. Application 210 includes a mailer determining section 212, mail class determining section 214, postage calculating section 216, and preferred seller determining section 218 (determining as used in this application means selecting from a pre-calculated table or calculating in real-time). These four components will be described in more detail below.

The database 220, among other things, is configured to store user profiles and product information. As an example, the database 220 is integrated in the server 205 and may include multiple storage devices linked to one another. According to one embodiment, the database 220 stores information of each seller offering a particular product for sale. For example, the database 220 stores the name, address, reliability rating, and transaction history of each seller. In addition, the database 220 stores information of each product offered for sale. For example, for each product (e.g. DVD, CD, book, camera, etc.), the database 220 stores the dimensions, weight, model/version, and condition of the product. The database may also store other information such as payment information, user preferences, and a reliability rating associated with a user.

The user terminals 202 and 208 are shown connected to network 204 for browsing the multi-vendor website provided by the server 205 (for buyers, to search for products to buy; for sellers, to post products for sale). The terminals 202 and 208 may be any type of computing device that provides network connectivity and allows a user to browse a website. For instance, terminals 202 and 208 may be a personal computer, a cellular phone, or a personal digital assistant. In one embodiment, seller terminals 208 represent a plurality of sellers that offer products to be sold on the multi-vendor website. User terminal 202 represents a buyer searching for a desired product offered on the multi-vendor website.

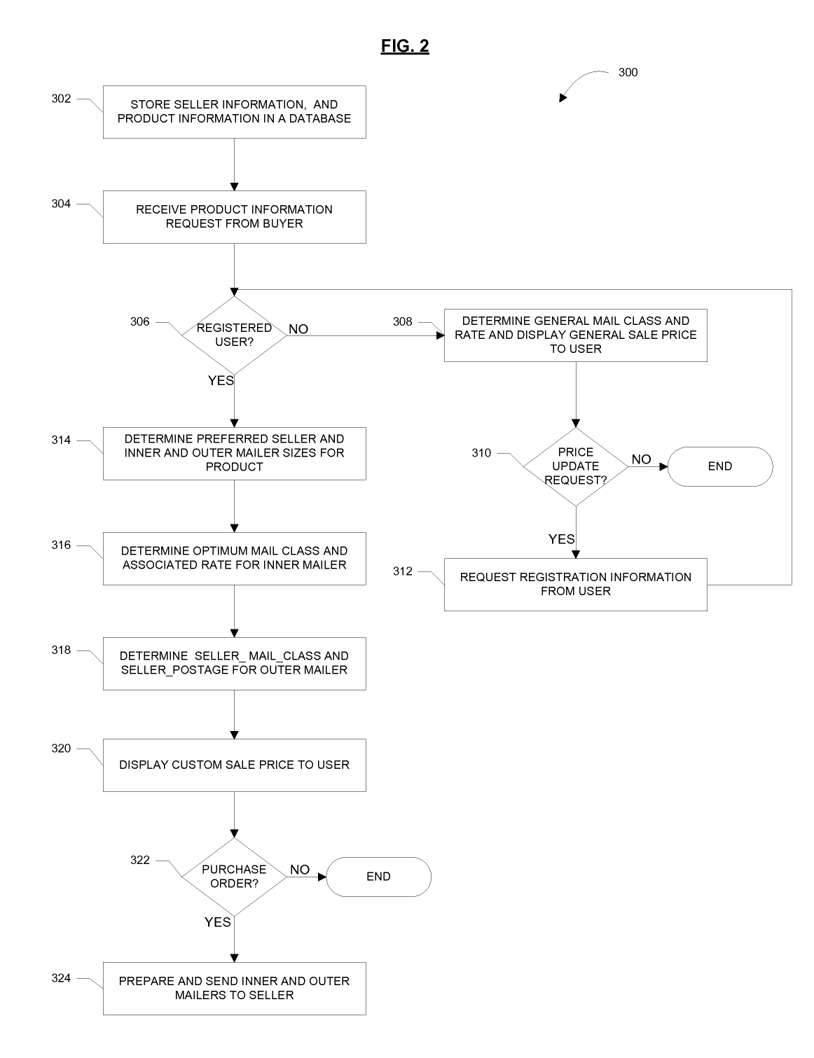

FIG. 2 is a simplified flowchart of the product distribution system according to an embodiment of the present invention. In step 302, the seller registers with the multi-vendor website by providing contact information, mailing address and billing information. In one embodiment, for most products, information about the product is already pre-stored in the database, and the seller simply selects the product that the seller has for sale. For example, each product has stored product information including a product identification number, product specifications, product model and/or version number, product dimensions, and product weight. In an alternate embodiment, or for rare products, the user can enter this information. The seller then enters the condition of the product (e.g. good, excellent, or new) and a preferred list price for the product. This data is stored in the database as seller information and product information, respectively. In the same or a separate database, registration information on buyers is stored, including the buyer shipping address and payment information (e.g., credit card number).

In step 304, the multi-vendor server receives a product information request from a user. The product information request includes identification information of a product including the product name, product model and/or version, and product condition. Additionally, the product information request can be generated when a user clicks on a picture illustration of a particular product.

In step 306, the server determines if the user is registered with the multi-vendor website. If the user is logged in, then the server determines that the user has previously registered on the multi-vendor website and proceeds to retrieve the user information (e.g. user address, billing information, etc.).

However, if the user is not registered with the multi-vendor website, in step 308, the server determines a general mail class and associated postal rate, and displays a general sale price to the user. In one embodiment, the server determines the general mail class and postal rate based on the longest national delivery time in mailing the product. The general mail class and postal rate are added to the list price of the item, creating a general sale price. The general sale price is then displayed to the user. In this way, the user is given up to the most expensive shipping price for the product at a particular mail class. In addition, a message is provided under the general sales price stating that the general sales price will change, or be updated, upon user registration with the multi-vendor website.

After displaying the general sales price to the user in step 308, in step 310, the user can then choose to update the sales price by registering with the multi-vendor website. If the user does not elect to update the price, the server performs no other functions. If the user does elect to update the general sales price, then in step 312, a registration information request form is displayed to the user. In one embodiment, the registration information request form includes the text boxes for entry of the user name, user address, and billing information.

After verifying that the user is registered with the multi-vendor website in step 306, in step 314, the server determines a preferred seller, and an inner mailer and outer mailer size. The multi-vendor website determines a preferred seller to deliver the product to be purchased by the user. In a specific embodiment, the multi-vendor website utilizes the preferred seller determining section 218 for selecting the preferred seller. The preferred seller determining section retrieves the buyer address from the purchase order and then queries the seller information in the database for a seller having a seller address geographically closest to the buyer address. Additional information may be used to determine the preferred seller such as the reliability rating of the seller including seller responsiveness and product description accuracy, item price, delivery speed, delivery cost, or even the listing date of the product may be used.

The inner mailer size is based on the dimensions and weight of the requested product. The multi-vendor website utilizes the mailer determining section 212, which retrieves from the database the product information associated with the requested product. The mailer determining section uses a look-up table including various mailer sizes, and matches the dimensions of the requested product with an inner mailer package having dimensions closest to the dimensions of the product. For example, if the requested product is a DVD, the mailer determining section selects an inner mailer having an appropriate size for sending that specific DVD (e.g. 8 by 11 inch number one bubble envelope). Alternately, the database includes a predetermined inner mailer size for each product description.

Further, the outer mailer size is determined based on the size of the inner mailer. The outer mailer is used to house the inner mailer in order to ship the inner mailer to the seller. As such, the outer mailer needs to be large enough to place the inner mailer within. In one embodiment, a list of outer mailer sizes are associated with a particular inner mailer size. For example, for an 8 by 11 inch number one bubble envelope, a 9 by 12 inch outer envelope may be used as the outer mailer.

Furthermore, in step 316, the multi-vendor website automatically determines an optimum mail class and optimum mail class postage for sending the inner mailer. The mail class determining section retrieves the seller address of the preferred seller, the product dimensions, and the product weight from the database. In addition, the buyer address is retrieved from the user registration information in the database. A look-up table of various mail classes are matched with the information retrieved. The mail class determining section considers the speed of the mail class, the price of the mail class, the location of the buyer and seller, and the seller reliability rating. Considering all of these factors, the mail class determining section determines the least expensive and/or fastest mail class service. In another embodiment, if the price differential between two mail class services is small, but the speed of delivery differential is substantial, then the user will be prompted with an option to expedite shipping. If the user selects the expedited shipping option, the more expensive mail class service is selected for shipping the product. In addition, the mail class determining section may consider the price of the product. If the price of a certain mail class is high in relation to the price of the product, then another mail class will be chosen.

Following step 316, in step 318 the multi-vendor website automatically calculates a seller mail class and associated seller postage for sending the outer mailer to the seller. The outer postage calculating section 216 of the application retrieves the weight and dimensions of the inner mailer from the mailer determining section, and the seller address from the database. The outer postage calculating section determines the third-party distribution center responsible for sending the outer mailer to the seller. In a similar fashion to the optimum mail class determining section described above, the outer postage calculating section determines the cheapest and/or fastest mail class for sending the outer mailer and inner mailer to the seller.

After step 318, in step 320, the rate of optimum mail class postage for the inner mailer and the rate of the seller postage for the outer mailer are added to the price of the requested product to create a custom sale price for the product requested by the user. The custom sale price is then displayed to the user along with a purchase button. In addition, an expected time for delivery, or the delivery speed, may be displayed to a registered user. If in step 322, the user clicks on the purchase button, thereby creating a purchase order, then in step 324, the inner and outer mailers are prepared for shipment to the seller. In one embodiment, the inner mailer is affixed with a buyer mailing label that includes the address of the buyer, the optimum mail class, and the optimum mail class postage. The outer mailer is affixed with the seller mailing label that includes the address of the seller, the seller mail class and the seller postage. After the buyer and seller labels are checked for accuracy, the inner mailer is then placed within the outer mailer for delivery to the seller. Alternatively, the inner mailer may be used as a reusable two way mailer. For example, a removable seller shipping label may overlie the buyer shipping label. In this case, upon receiving the reusable mailer, the seller simply removes the seller shipping label to reveal the buyer shipping label.

In another embodiment, a single mailer may be used as a multi-use mailer. In this case, the seller can print a pre-addressed buyer shipping label from a local computer and affix the buyer shipping label over the original seller shipping label. This allows the single mailer to be used multiple times by multiple parties. Moreover, in the case of a bulk seller, multiple multi-use mailers may be pre-sold to a particular bulk seller.

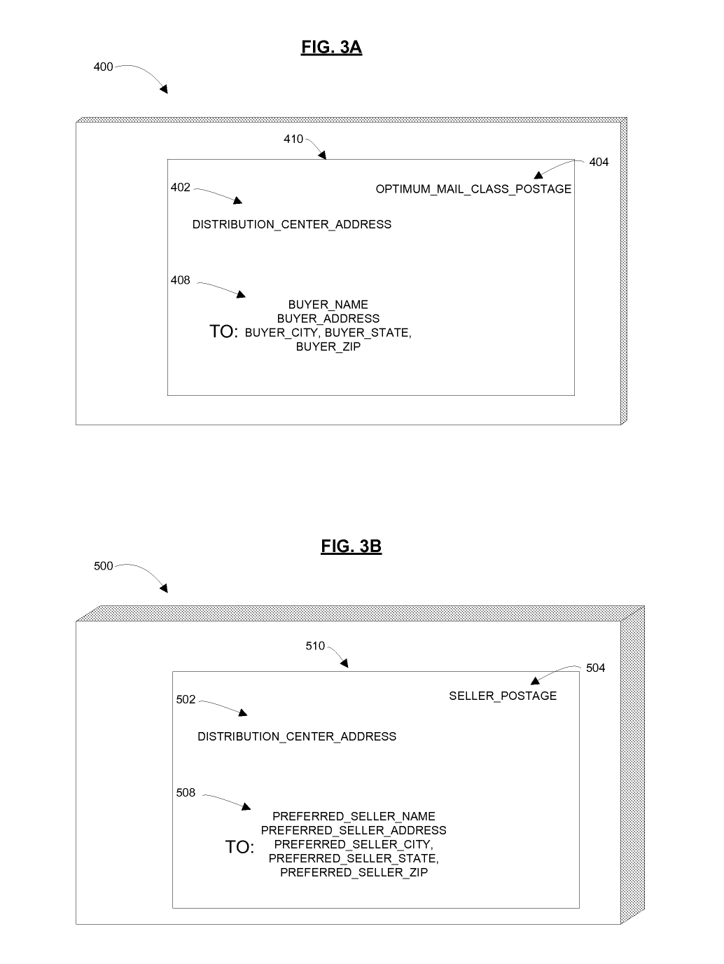

FIG. 3A is a simplified perspective view of an inner mailer according to an embodiment of the present invention. As shown, the inner mailer 400 includes a buyer shipping label 410. The buyer shipping label is made from an adhesive and is affixed to the inner mailer 400. Alternatively, the buyer shipping label could be printed directly on the inner mailer 400. The buyer shipping label includes the buyer information 408, and the optimum mail class postage 404 from the optimum mail class determining section. Additionally, the distribution center address 402 may be included on the buyer shipping label 410 as a return to sender address.

FIG. 3B is a simplified perspective view of an outer mailer according to an embodiment of the present invention. As shown, the outer mailer 500 includes a seller shipping label 510. The seller shipping label 510 is made from an adhesive and affixed to the outer mailer 500. The seller shipping label 510 includes the preferred seller name and address 508, and the seller postage 504. Additionally, the distribution center address may be included on the seller shipping label 510 as a return address.

The product distribution system is not limited to the embodiments described above. For example, the server system and multi-vendor website may include tracking information for each product shipped to a user. This tracking information would be provided on the inner mailer and/or the outer mailer for tracking the product from the seller to the buyer, buyer to seller (in the case of returns), or from the distribution center to the seller. Accordingly, the buyer and seller can both track the inner mailer and product using the tracking information provided by the multi-vendor website. Additionally, the multi-vendor website can use the tracking information to provide electronic notifications (eg. email, text message, etc.) to the seller and buyer regarding the shipment status of the product.

Alternatively, in the case where the buyer is dissatisfied with the received product, the inner and outer mailers may be sent to the buyer for returning the product to the seller. In this case, the optimum mail class determination would remain the same (same buyer and seller address), however, the postage for the outer mailer would be determined from the distribution center to the buyer.

Although the embodiments have been described with reference to products such as DVDs, CDs, and books, the product distribution system can also apply to video games, consumer electronics (i.e., PDAs, cell phones, etc.), jewelry, toys, software or any other product or service. In addition, the products can be delivered by any class of any delivery service, such as the United States Postal Service (USPS), United Parcel Service (UPS), FedEx, or any other delivery service. In addition to sale transactions, the product distribution system according to embodiments of the present invention may also apply to rental or barter transactions.

It will be recognized by persons of ordinary skill in the art that the method of the invention has many applications, and that this description has not attempted to enumerate all possible variations. The scope of the invention also extends to various combinations and modifications that may fall within the spirit of the appended claims.

What is claimed is:

1. A method for distributing a product, the method comprising:
storing seller information for a plurality of sellers in a database, the seller information including a seller address and product information associated with a product to be sold over the internet; wherein the product information includes product size and product weight;
storing buyer address information:
receiving a purchase order from a buyer, the purchase order including at least one product to be purchased from one of the plurality of sellers;
determining an appropriate mailer to send to a seller based upon the product size and product weight;
determining an optimum mail class and optimum mail class postage based upon the buyer address, the seller address, and the product size and the product weight of the product to be purchased; and
sending the mailer to the seller.

2. The method of claim 1 wherein a preferred seller is selected based upon a delivery speed, a delivery cost, and a reliability rating associated with the seller.

3. The method of claim 2 further comprising determining an appropriate package for housing the mailer based on the size of the mailer.

4. The method of claim 3 wherein:
a buyer mailing label is affixed on the mailer and includes the buyer address, the optimum mail class, and the optimum mail class postage; and
a seller mailing label is affixed on the packing housing the mailer and includes the seller address, a seller mail class, and a seller postage.

5. The method of claim 1 wherein the mailer comprises:
a buyer mailing label including the buyer address, the optimum mail class, and the optimum mail class postage; and
a removable seller label overlying the buyer mailing label and including the seller address, a seller mail class, and a seller postage.

6. The method of claim 1 wherein the mail class is a mail class service provided by USPS, UPS, or Fed Ex.

7. The method of claim 1 wherein the mailer includes tracking information.

8. The method of claim 3 wherein the mailer housing includes tracking information.

9. The method of claim 7 or 8 further comprising sending an electronic notification to the buyer and the seller regarding the status of the product to be purchased based on the tracking of said mailer using said tracking information.

10. The method of claim 1 wherein a preferred distribution center having a shortest delivery time is selected from a plurality of distribution centers, wherein the preferred distribution center is responsible for sending the mailer to the seller.

11. A computer-implemented system for distributing a product sold over the internet, the system comprising:
a database configured to store (a) seller information for a plurality of sellers, the seller information including a seller address, and product information for a product to be sold over the internet, the product information including product dimension and product weight, and (b) buyer information for a plurality of buyers, said buyer information including a buyer shipping address and payment information;
a communication interface configured to receive a purchase order from a buyer, the purchase order including at least one product to be purchased from one of the plurality of sellers; and
computer readable media including computer readable code for a software application comprising:
a mailer determining section configured to determine a mailer to send to a seller based upon the product dimension and weight;
a mail class determining section configured to determine an optimum mail class and optimum mail class postage based upon the buyer address, the seller address, the product dimension and the product weight of the product to be purchased; and
a postage amount calculating section configured to calculate a postage amount based upon the mailer, the buyer address, and seller address.

12. The system of claim 11 wherein the software application further comprises a preferred seller determining section configured to determine a preferred seller based upon a delivery speed, a delivery cost, and a reliability rating associated with the seller.

13. The method of claim 12 wherein the mailer determining section determines an appropriate package for housing the mailer based on the size of the mailer and the preferred seller address.

14. The method of claim 13 wherein:
a buyer mailing label is affixed to the mailer and includes the buyer address, the optimum mail class, and the optimum mail class postage; and
a seller mailing label is affixed to the package housing the mailer and includes the preferred seller address, a seller mail class, and a seller postage.

15. The method of claim 11 wherein the mailer comprises:
a buyer mailing label including the buyer address, the optimum mail class, and the optimum mail class postage; and
a removable seller label overlying the buyer mailing label and including the seller address and a seller postage.

16. The system of claim 11 wherein the mail class is a mail class service provided by USPS, UPS, or Fed Ex.

17. The system of claim 11 wherein the mailer includes tracking information.

18. The system of claim 11 wherein the mailer housing includes tracking information.

19. The system of claim 17 or 18 wherein an electronic notification is sent to the buyer and the seller regarding the status of the to be purchased product based on the tracking information.

20. The system of claim 11 wherein a preferred distribution center having a shortest delivery time is selected from a plurality of distribution centers, wherein the preferred distribution center is responsible for sending the mailer to the seller.
